(19) United States
(12) Patent Application Publication
(10) Pub. No.: US 2011/0044887 A1
(43) Pub. Date: Feb. 24, 2011

(54) MESOPOROUS MANGANESE DIOXIDE

(75) Inventors: Katherine Elizabeth Amos, Eastleigh (GB); Tobias James Gordon-Smith, Eastieigh (GB)

Correspondence Address: FOLEY & LARDNER LLP, P.O. BOX 80278, SAN DIEGO, CA, 92138-0278, US

(73) Assignee: Nanotecture Ltd.

(21) Appl. No.: 12/921,564

(22) PCT Filed: Mar. 25, 2009
(86) PCT No.: PCT/GB2009/000797

§ 371 Date: Nov. 10, 2010

(30) Foreign Application Priority Data
Mar. 26, 2008 (GB) 0805509.7

(51) Int. Cl. C01G 45/02

(52) U.S. Cl. 423/605

(57) ABSTRACT

α-Phase manganese dioxide, when in a mesoporous form, has useful properties enabling its use as electrodes, inter alia, in lithium batteries and supercapacitors.

The present invention relates to mesoporous manganese dioxide in the alpha phase.

Manganese dioxide (MnO₂) is used as a positive electrode material in a range of electrochemical cells, including primary lithium batteries, lithium ion batteries and asymmetric supercapacitor devices. Lithium and lithium ion batteries use organic (non-aqueous) electrolytes and rely on reaction of the MnO₂ with lithium ions contained within the electrolyte to store charge. In contrast, supercapacitors that use MnO₂ as their positive electrodes tend to use aqueous electrolytes and rely on the reaction of protons (H⁺) with the MnO₂ to store charge. Despite these differences, the basic mechanism of ion intercalation is the same. In this process, the cation from the electrolyte (Li⁺ or H⁺) moves into the structure of the MnO₂ by solid state diffusion in order to reach reaction sites during the discharge process. Movement of the cations through the solid is facilitated by spacings in the crystallographic lattice. As such, the rate at which charging and discharging can be carried out depends on the ease with which H⁺ or Li⁺ ions are able to move rapidly through the MnO₂.

One of the battery systems capable of using the present invention is the Li MnO₂ system in which the negative electrode consists in a lithium metal foil and the positive electrode comprises manganese dioxide. According to the Handbook of Battery Materials [published by Wiley-VCH, (1999), p. 32] one of the requirements for MnO₂ in the Li—MnO₂ battery is an optimised crystal structure suitable for the diffusion of Li⁺ ions into the MnO₂ structure.

Manganese dioxide can exist in several different crystallographic forms, commonly referred to as the α, β, γ, ramsdellite or δ-phases. The main factor determining which of these structures predominates is the number and nature of impurities in the MnO₂. These factors are well known to those skilled in the art.

Batteries of the Li—MnO₂ type typically use MnO₂ with a crystallographic structure that is a mixture of β and γ or ramsdellite phases. U.S. Pat. No. 5,658,693 describes an electrode material and electrochemical cell made therefrom consisting of MnO₂ in the ramsdellite form. Mixtures of the β/γ phases have been shown to provide the best structure for Li⁺ ion diffusion, as these contain fewer impurities than other crystallographic forms. Impurities usually consist of large cation species, such as K⁺, Na⁺ or Rb⁺, and these ions occupy the channels through which Li⁺ must move in order to function as part of the charge storage mechanism. Thackeray in “Progress in Solid State Chemistry”, vol. 25, p. 1, (1997) teaches that electrostatic repulsions between these large positive ions and the smaller positively charged Li⁺ ions impede the movement of Li⁺ through the crystal lattice, manifesting as poor electrochemical performance in the battery. The same phenomena can affect electrochemical performance in electrochemical cells employing aqueous electrolytes where the movement of H⁺ cations can be impeded.

For example, WO 01/87775 describes a method of making nanoporous MnO₂ using a liquid crystalline templating approach. The authors point out, however, that the methods disclosed typically produce MnO₂ in the δ-phase and that the preferred crystallographic form for use in an electrochemical cell is the γ-form. As such, the δ-phase materials produced from the liquid crystal synthesis step require post-treatment in order to form the desired γ-phase, adding an extra process step and thus extra costs.

α-phase MnO₂ is one of the easiest forms of MnO₂ to synthesise. However, it is not used in commercial battery or supercapacitor systems. α-MnO₂ contains large cation impurities, such as K⁺, Na⁺ or Rb⁺ which are often retained within the crystallographic structure as a remnant of the synthesis process. Since these large ions occupy the intercalation spaces in the material, this imparts poor charge/discharge performance. Ohzuku and co-authors in the Journal of the Electrochemical Society, vol. 138, No. 2, p 360 describe sloping discharge curves or distorted S-shaped discharge curves when using α-phase MnO₂ materials containing either K⁺ or Rb⁺ cationic impurities compared with those of heat treated MnO₂ of the γ-phase. This poorer electrical performance is attributed to the effect of electrostatic interactions between intercalating Li⁺ ions and cations contained within the α-phase material. It is possible to fabricate α-MnO₂ without large cation impurities present (such as by performing cation exchange to replace the large cation's with smaller Li⁺ stabilising ions) and these materials perform better than α-MnO₂ containing other impurities. However, this route introduces additional process steps and cost in the production process.

Surprisingly, we have found that α-MnO₂ synthesised using a liquid crystal templating approach and having a mesoporous form but including large cation impurities exhibits very good performance as a high power battery electrode material in the Li—MnO₂ system and will, therefore, exhibit similarly good behaviour in other related systems. Although we do not wish to be limited by any theory, we believe that the presence of the nanostructure and resulting very short Li⁺ ion diffusion distances facilitates the rapid movement of these ions despite the presence of large cation impurities that would normally hinder Li⁺ ion movement in a conventional material.

Thus, the present invention consists in mesoporous α-manganese dioxide.

In another aspect, the present invention provides an electrode comprising mesoporous α-manganese dioxide.

In a still further aspect, the present invention provides an electrochemical cell having an electrode comprising mesoporous α-manganese dioxide.

Although the material the subject of the present invention is commonly referred to as manganese dioxide and represented by the formula MnO₂, it will be understood that most samples of so-called manganese dioxide do not adhere strictly to this formula, and could more properly be considered mixtures of oxides of Mn(IV) and Mn(III) in varying proportions, and thus represented by the formula MnOₓ, where x is a number which generally falls within the range of from 2 to 1.8. A discussion of the various non-stoichiometric compounds included in the term “manganese dioxide” appears in “Studies On MnO₂−1. Chemical Composition, Microstructure and Other Characteristics of Some Synthetic MnO₂ of Various Crystalline Modifications” by K. M. Parida et al [Electrochimica Acta, Vol. 26, 435-443 (1981)]. Equally, the presence of cationic impurities within the spaces in the MnO₂ crystallographic structure can affect the stoichiometry of the material such that materials with the general formula M_{4y}Mn_{(1-y)}Oₓ (in the case where M is a mono-valent cation) and M_{2y}Mn_{(1-y)}Oₓ (where M is a di-valent cation) are formed. In these cases y generally lies in the range 0 to 0.25. In cases where the cationic impurities are composed of more than one type of cation, M encompasses all of the cations involved and y refers to the stoichiometric sum of all of such cations. All such materials are included in the term “manganese dioxide” and the formula “MnO₂”, as used herein.

Mesoporous materials of the type the subject of the present invention are sometimes referred to as “nanoporous”, as they are, for example, in WO 01/87775. However, since the prefix “nano” strictly means 10⁻⁹, and the pores in such materials may range in size from values of the order of 10⁻⁸ to 10⁻⁹ m, e.g. from 1.3 to 20 nm, it is better to refer to them, as we do here, as “mesoporous”.

The present invention still further provides a process for the preparation of manganese dioxide by the oxidation of a source of Mn(II), reduction of a source of Mn(VI) or Mn(VII), or dissociation of an Mn(II) salt, characterised in that the oxidation, reduction or dissociation reaction is carried out in the presence of a structure-directing agent in an amount sufficient to form an homogeneous lyotropic liquid crystalline phase in the reaction mixture, and under conditions such as to precipitate the manganese dioxide as a mesoporous solid in the α-phase. The oxidation, reduction or dissociation may be carried out by chemical or electrochemical means.

In the accompanying drawings:

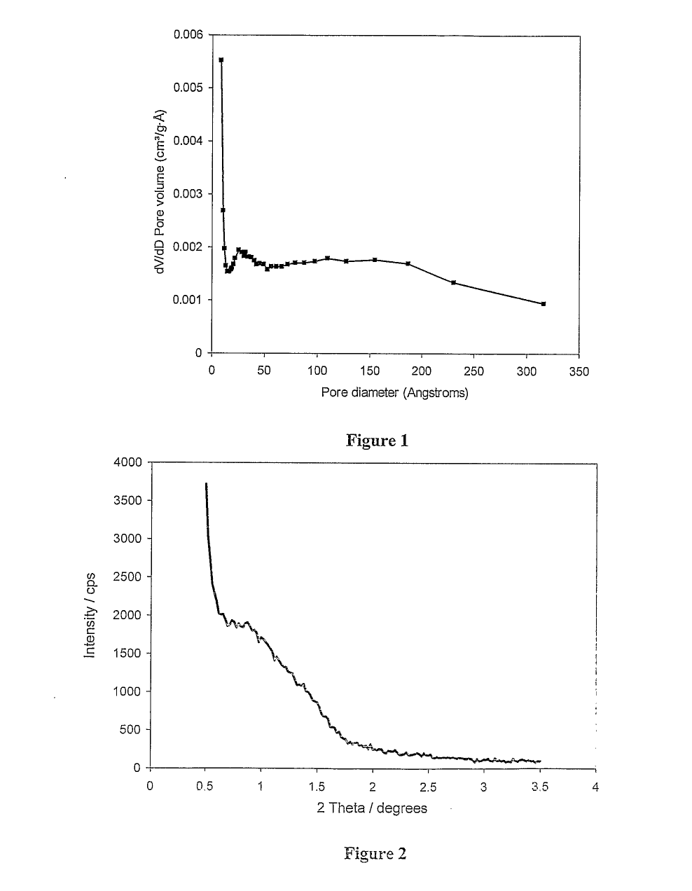

FIG. 1 shows the pore size distribution determined by nitrogen desorption of the product of Example 1;

FIG. 2 shows the small angle x-ray scattering peak of the product of Example 1, indicating the presence of some ordering on the mesoscale;

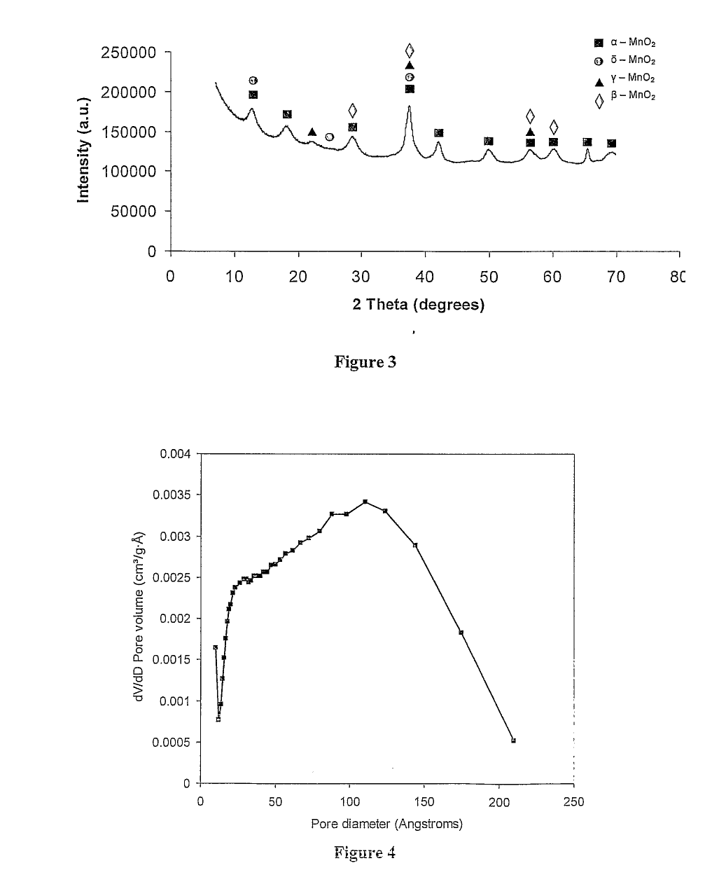

FIG. 3 shows the wide angle x-ray diffraction pattern of the product of Example 1, indicating the predominance of the α-phase of MnO₂;

FIG. 4 shows the pore size distribution determined by nitrogen desorption of the product of Example 2;

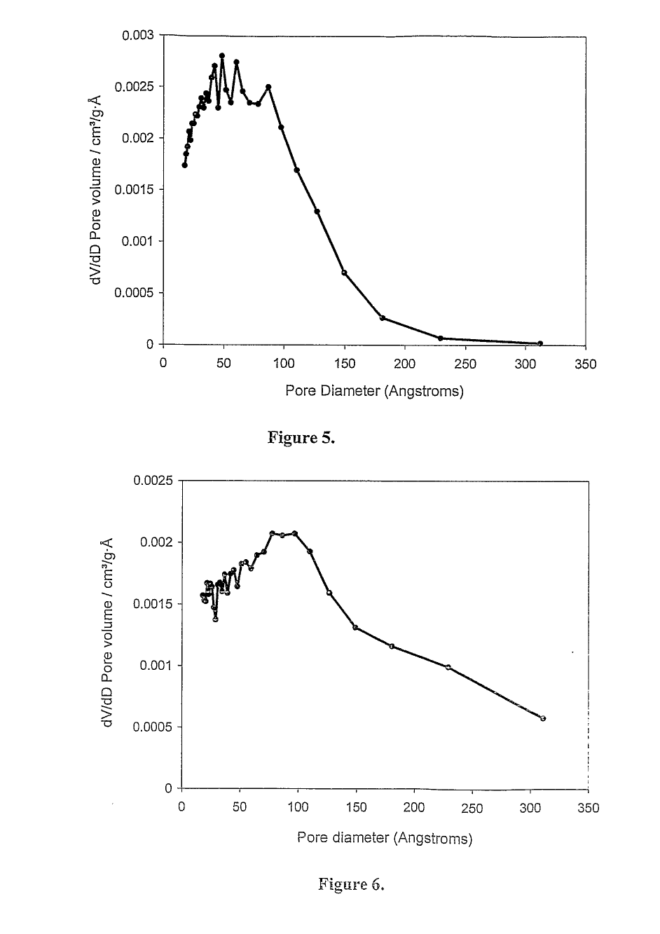

FIG. 5 shows the pore size distribution of the material of Example 5;

FIG. 6 shows the pore size distribution of the material of Example 6; and

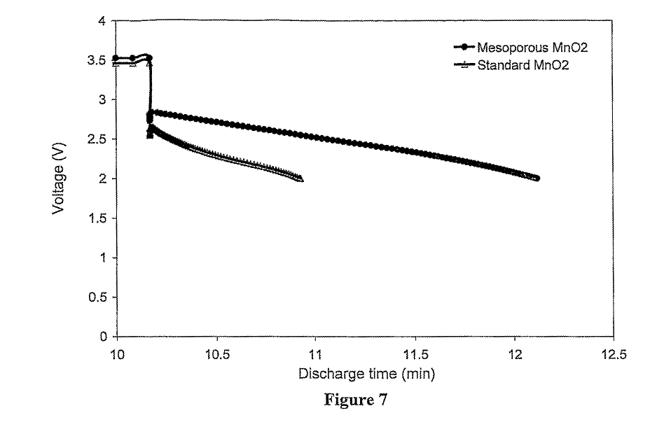

FIG. 7 shows the discharge curves for the cells of Example 9.

Any suitable amphiphilic organic compound or compounds which will not adversely affect the MnO₂-foaming reaction and which is capable of forming an homogeneous lyotropic liquid crystalline phase may be used as the structure-directing agent, either low molar mass or polymeric. These compounds are also sometimes referred to as organic directing agents. They are generally surfactants. In order to provide the necessary homogeneous liquid crystalline phase, the amphiphilic compound will generally be used at a high concentration, although the concentration used will depend on the nature of the compound and other factors, such as temperature, as is well known in the chemical industry. Typically at least about 10% by weight, preferably at least 20% by weight of the amphiphilic compound is used, but preferably no more than 95%, by weight, based on the total weight of the solvent and amphiphilic compound. Most preferably, the amount of amphiphilic compound is from 30 to 80%, especially from 40 to 75%, by weight, based on the total weight of the solvent and amphiphilic compound.

Suitable compounds include organic surfactant compounds capable of forming aggregates, and preferably of the formula RₚQ wherein R represents a linear or branched alkyl, aryl, aralkyl, alkylaryl, steroidal or triterpene group having from 6 to about 6000 carbon atoms, preferably from 6 to about 60 carbon atoms, more preferably from 12 to 18 carbon atoms, p represents an integer, preferably from 1 to 5, more preferably from 1 to 3, and Q represents a group selected from: [O(CH₂)ₘ]ₙOH wherein m is an integer from 1 to about 4 and preferably m is 2, and n is an integer from 2 to about 100, preferably from 2 to about 60, and more preferably from 4 to 14; nitrogen bonded to at least one group selected from alkyl having at least 4 carbon atoms, aryl, aralkyl and alkylaryl; phosphorus or sulphur bonded to at least 2 oxygen atoms; and carboxylate (COOM, where M is a cation, or COOH) groups.

General classes of surfactant which may be used in the present invention include: alkyl sulphosuccinamates; alkyl sulphosuccinates; quaternary ammonium surfactants; fatty alcohol ethoxylates; fatty alcohol ethoxysulphates; alkyl phosphates and esters; alkyl phenol ethoxylates; fatty acid soaps; amidobetaines; aminobetaines; alkyl amphodiacetates; and ethylene oxide/propylene oxide block copolymers, e.g. of the type sold under the trade name ‘Pluronics’.

Preferred examples include cetyl trimethylammonium bromide, cetyl trimethylammonium chloride, sodium dodecyl sulphate, sodium dodecyl sulphonate, sodium bis(2-ethylhexyl) sulphosuccinate, and sodium soaps, such as sodium laurate or sodium oleate; sodium dodecyl sulphosuccinamate; hexadecyl tetraethylene glycol sulphate; and sodium dodecyl hydrogen phosphate.

Other suitable structure-directing agents include monoglycerides, phospholipids, glycolipids and amphiphilic block copolymers, such as di-block copolymers composed of ethylene oxide (EO) and butylene oxide (BO) units.

Preferably non-ionic surfactants such as octaethylene glycol monododecyl ether (C₁₂EO₈, wherein EO represents ethylene oxide), octaethylene glycol monohexadecyl ether (C₁₆EO₈) and non-ionic surfactants of the Brij series (trade mark of ICI Americas), are used as structure-directing agents.

In almost all cases, it is expected that the manganese-containing compound will dissolve in the hydrophilic domain of the liquid crystal phase, but it may be possible to arrange that it dissolves in the hydrophobic domain.

The reaction mixture may optionally further include a hydrophobic additive to modify the structure of the phase, as explained more fully below. Suitable additives include n-hexane, n-heptane, n-octane, dodecane, tetradecane, mesitylene, toluene and triethyleneglycol dimethyl ether. The additive may be present in the mixture in a molar ratio to the structure-directing agent in the range of 0.1 to 10, preferably 0.5 to 2, and more preferably 0.5 to 1.

The mixture may optionally further include an additive that acts as a co-surfactant, for the purpose of modifying the structure of the liquid crystalline phase or to participate in the chemical reactions. Suitable additives include n-dodecanol, n-dodecanethiol, perfluorodecanol, compounds of structures similar to the surfactants exemplified above but with a shorter chain length, primary and secondary alcohols (e.g. octanol), pentanoic acid or hexylamine. The additive may be present in the mixture in a molar ratio to the structure-directing agent in the range of 0.01 to 2, and preferably 0.08 to 1.

It has been found that the pore size of the deposited MnO₂ can be varied by altering the hydrocarbon chain length of the surfactant used as structure-directing agent, or by supplementing the surfactant by an hydrocarbon additive. For example, shorter-chain surfactants will tend to direct the formation of smaller-sized pores whereas longer-chain surfactants tend to give rise to larger-sized pores. The addition of an hydrophobic hydrocarbon additive such as n-heptane, to supplement the surfactant used as structure-directing agent, will tend to increase the pore size, relative to the pore size achieved by that surfactant in the absence of the additive. Also, the hydrocarbon additive may be used to alter the phase structure of the liquid crystalline phase in order to control the corresponding regular structure of the deposited material.

Most commercial grades of surfactant will contain or will be capable of exhibiting reducing action, and so, where the MnO₂ is to be prepared by a reduction reaction, they may be able to provide both the structure-directing agent and the reducing agent. For example, octaethylene glycol monohexadecyl ether contains hydroxyl groups capable of facilitating reduction, and, in those cases where there is an intrinsic reducing agent, an extrinsic reducing agent may not be necessary, although, in many cases, it may also be desirable.

A variety of chemical methods is available to prepare manganese dioxide, and these are well known to those skilled in the art. In principle, any known method may be used, although care should be taken that the structure directing agent does not interfere with the reaction or that the reagents do not interfere with the structure directing agent.

Examples of suitable reactions which may be employed in the process of the present invention include the following:

### 1. Reduction of Permanganate or Manganate

In this reaction, a permanganate or manganate, normally and preferably in aqueous solution, is reduced with a reducing agent.

There is no particular restriction on the permanganate or manganate to be used, provided that it is at least minimally, and preferably substantially, soluble in the reaction medium. Preferred, and commonly available, permanganates include potassium permanganate, sodium permanganate, lithium permanganate and ammonium permanganate, of which potassium or sodium permanganate is preferred. Preferred, and commonly available, manganates include potassium manganate, sodium manganate, lithium manganate and ammonium manganate, of which potassium or sodium manganate is preferred.

The concentration of the permanganate or manganate is preferably from 0.1 to 0.5M with respect to the aqueous component of the reaction mixture. Too low a concentration reduces the yield of the desired product to too low a level, whilst we have found that too high a concentration leads to a loss of the desired structure and of nanoporosity. Within this range, however, the concentration may be chosen freely.

The pH of the mixture would normally be expected to be slightly acid, perhaps around 6, and this is acceptable in the present invention. However, it may, in some cases be desirable to adjust the acidity, by the addition of an acid to achieve a pH in the range of from about 4 to about 5 before beginning the reduction reaction. However, it should be noted that, if the pH is too low, the permanganate may begin to decompose prematurely.

The reaction is normally and preferably effected at atmospheric pressure. However, if desired, it may be carried out under superatmospheric pressure. For example, it may be carried out under hydrothermal conditions, in which the reaction is effected in a sealed vessel under endogenous pressure.

The reaction can take place over a wide range of temperatures, and the precise reaction temperature is not critical to the invention. The preferred reaction temperature will depend upon such factors as the nature of the solvent, and the starting material or reagent used. However, in general, we find it convenient to carry out the reaction at a temperature of from 4° C. to below the boiling point of the reaction mixture. Thus, if the reaction is carried out under atmospheric or superatmospheric pressure, a preferred temperature range is from 4° to 200° C. more preferably from 10° to 90° C., and most preferably from 20° to 90° C. The time required for the reaction may also vary widely, depending on many factors, notably the reaction temperature and the nature of the reagents and solvent employed.

Since permanganates are generally powerful oxidising agents, it is preferred that the reducing agent used should not be too reactive, since the resulting reaction could be undesirably violent, which could result in damage to the desired nanoporous structure. Within these constraints, however, the reducing agent may be chosen freely from a wide range of readily available materials. Indeed, as discussed below, many commercial surfactants (which may be used as the structure-directing agent) contain or are themselves reducing agents, and so an extrinsic reducing agent may be unnecessary.

Examples of suitable extrinsic reducing agents include various organic compounds, including:

alcohols, which may be aliphatic or aromatic, for example:
1-n-alkanols, such as ethanol, propanol, decanol or dodecanol;
diols, such as ethylene glycol;
triols, such as glycerol;
higher alcohols, such as glucose; and
esters of polyhydric alcohols, such as diethylene glycol monomethyl ether or diethylene glycol monomethyl ether;
aromatic alcohols, such as benzyl alcohol or phenol;

aldehydes, which may be aliphatic or aromatic, for example:
formaldehyde, acetaldehyde or benzaldehyde;

certain aliphatic carboxylic acids, for example:
citric acid or tartaric acid;

inorganic compounds, including:
hydrazine hydrate and sodium borohydride.
   2. Oxidation of an Mn(II) Salt with an Oxidising Agent

In this reaction, an Mn(II) salt is oxidised using an oxidising agent such as a permanganate. In this case, where a permanganate is used as the oxidising agent, it is reduced and likewise yields MnO₂.

Where the oxidising agent is a permanganate, this may be any of the permanganates exemplified above in reaction 1. Examples of other oxidising agents which may be used include: persulphates, for example ammonium, sodium or potassium persulphate; persulphuric acid; chlorates, for example sodium or potassium chlorate; and nitrites, for example sodium or potassium nitrite.

There is no restriction on the nature of the Mn(II) salt, provided that it is soluble in the reaction medium, and any suitable salt may be employed, for example manganese nitrate or manganese sulphate, of which the nitrate is preferred because of its better solubility. Manganese nitrate, if used, should not be used in a molar excess with respect to the permanganate, since it may then give the gamma crystalline form of MnO₂.

This reaction takes place very fast. It is not, therefore, possible simply to mix the reagents and the structure-directing agent, as the reaction will take place before the liquid crystal phase has a chance to form. Accordingly, in order successfully to carry out this reaction, it is desirable to use a “one pot” approach. One way of achieving this is to prepare a liquid crystal phase containing the Mn(II) salt and a surfactant and add a concentrated solution of permanganate thereto. Because of solubility limitations, we prefer to use sodium permanganate in this case. Alternatively, it is possible to prepare two liquid crystal phases, one containing the Mn(II) salt and the other the oxidising agent, e.g. permanganate, and each containing surfactant, in approximately equal concentrations and then mix the two phases.

The reaction solvent is normally and preferably aqueous and may be simply water. However, especially where the Mn(II) salt is manganese nitrate, a weak solution of nitric acid is preferred.

The reaction can take place over a wide range of temperatures, and the precise reaction temperature is not critical to the invention. The preferred reaction temperature will depend upon such factors as the nature of the solvent, and the starting material or reagent used. However, in general, we find it convenient to carry out the reaction at a temperature of from 4° C. to below the boiling point of the reaction mixture. Thus, if the reaction is carried out under atmospheric or superatmospheric pressure, a preferred temperature range is from 4° to 200° C. more preferably from 10° to 95° C., and most preferably from 40° to 90° C. The time required for the reaction may also vary widely, depending on many factors, notably the reaction temperature and the nature of the reagents and solvent employed.

The reaction is normally and preferably effected at atmospheric pressure. However, if desired, it may be carried out under superatmospheric pressure. For example, it may be carried out under hydrothermal conditions, in which the reaction is effected in a sealed vessel under endogenous pressure.

An especially preferred synthetic procedure is as follows, using the ‘one pot’ approach. A hexagonal phase of surfactant, preferably sodium dodecyl sulphonate, is formed, using a solution of the manganese salt, e.g. manganese nitrate, preferably a concentration of about 0.25M. The amount of surfactant is preferably about 45%, based on the weight of surfactant and water. To this is added a concentrated (e.g. 1M) solution of the oxidising agent, e.g. sodium permanganate. The mixture is then reacted at a temperature of about 75° C.

3. Reaction of Ozone with Manganese II Salts.

In this reaction, a manganese II salt in solution in a suitable solvent is reacted with ozone. This could be regarded as a sub-class of reaction 2, but, since the preferred operating conditions are different, it is treated separately. Examples of manganese salts which may be used are as given for reaction 2.

The solvent is suitably water. The reaction is preferably effected at an acid pH, for example a pH of from 0.5 to 4, preferably 1.5 to 2.5 and more preferably about 2.

The reaction can take place over a wide range of temperatures, and the precise reaction temperature is not critical to the invention. The preferred reaction temperature will depend upon such factors as the nature of the solvent, and the starting material or reagent used. However, in general, we find it convenient to carry out the reaction at a temperature of from 30° to 80° C., more preferably from 50° to 70° C., and most preferably about 60° C. The time required for the reaction may also vary widely, depending on many factors, notably the reaction temperature and the nature of the reagents and solvent employed.

The ozone may be bubbled gently through the reaction mixture, or the reaction may be simply carried out in an atmosphere of ozone.

### 4. Hydrothermal Decomposition of Manganese II Salts.

In this reaction, a manganese II salt in solution in a suitable solvent is decomposed hydrothermally. Examples of manganese salts which may be used are as given for reaction 2.

In order for the reaction to proceed, the solvent should be aqueous and is preferably simply water.

The reaction is normally and preferably effected in a sealed reaction vessel under autogenous pressure, which will normally be from 3 to 40 bar, more preferably from 3 to 39 bar, and most preferably from 3 to 4 bar.

The reaction can take place over a wide range of temperatures, and the precise reaction temperature is not critical to the invention. The preferred reaction temperature will depend upon such factors as the nature of the solvent, and the starting material or reagent used. However, in general, we find it convenient to carry out the reaction at a temperature of from 100° to 200° C., more preferably from 150° to 200° C. The time required for the reaction may also vary widely, depending on many factors, notably the reaction temperature and the nature of the reagents and solvent employed.

In this case, there are restrictions on the nature of the structure-directing agent which may be used, as it must be stable at temperatures up to about 200° C. and must be capable of forming a liquid crystal phase at such temperatures.

Many other chemical routes are known for the preparation of manganese dioxide, and any of these may be used in the process of the present invention, provided that they are not incompatible with structure-directing agents, such as surfactants, and that they can be, if necessary, modified to take place at such a rate as to permit the formation of a liquid crystal phase.

After completion of the reaction forming the MnO₂, the desired product may be separated from the reaction mixture by conventional means. For example, where the reaction is effected at elevated temperature, the reaction mixture is allowed to cool, and then the structure-directing agent is removed by washing. Since the structure-directing agent is normally a surfactant, this may be achieved by washing with deionised water, followed by centrifugation. This is repeated several times until no more foaming is observed, indicating absence of the surfactant. The resulting manganese dioxide may then be dried by gentle heating, for example at a temperature from about 40 to about 100° C., more preferably about 60° C.

Equivalent electrochemical reactions to those chemical reactions described above may also be used. One such process involves the direct electrolysis of an aqueous bath of manganese sulphate and sulphuric acid. Here, the Mn (II) ions of manganese sulphate are oxidised to MnO₂ at the anode of an electrodeposition cell when a voltage or current sufficient to facilitate deposition is applied. Another suitable process for the electrodeposition of MnO₂ involves a similar oxidative process in which Mn (II) is oxidised to MnO₂. This process uses an electrodeposition bath consisting of manganese sulphate, ammonium sulphate as a complexing agent maintained at a pH of approximately 8 via the addition of sulphuric acid or ammonium hydroxide. These methods of electrolytically forming MnO₂ are well known to those skilled in the art.

It will be noted that many of these reactions are, in general terms, similar to those suggested in WO 01/87775, which are said to lead to the preparation of the δ-phase MnO₂. It is well known to those skilled in the art that, as explained above, the crystallographic structure obtained depends on the nature and level of impurities in the final product. A greater level of impurities in the final product predisposes it to the α-configuration, while a lesser amount of impurities predisposes it to the δ-configuration. Thus, in order to achieve the δ-configuration of the products of WO 01/87775, greater care and higher purity starting materials needed to be used than are used in the present invention, thus giving the present invention a significant advantage in convenience and cost.

From this, it is apparent that any MnO₂ product is likely to contain several different phases, and so the product of the present invention is likely to contain δ-phase MnO₂ and possibly the β and γ phases in addition to the α-phase. The present invention relates to α-phase MnO₂, by which we mean MnO₂ containing a majority of the compound in the α-phase. More preferably, at least 60%, still more preferably at least 80% and most preferably at least 90%, of the MnO₂ is in the α-phase.

In general, the mesoporous α-manganese dioxide of the present invention will contain some impurities, commonly K⁺, Na⁺ or Rb⁺, or any combination of them. Normally, the content of these impurities is at least 0.2 atomic %, and more commonly at least 0.7 atomic %. In general, the impurities will not exceed 5 atomic %.

The mesoporous MnO₂ of the present invention will normally be produced in particulate form as a consequence of either being produced by chemical methods in which a powder product is usually formed, or by electrochemical methods in which deposited materials are ground after completion of the electrodeposition process. These particles commonly have an internal porosity of at least 15%, and preferably most of their surface area (i.e. at least 50%, more preferably at least 75%, most preferably at least 90%) is due to the presence of pores in the meso-range (i.e. 10⁻⁸ to 10⁻⁹ m). This distinguishes the materials of the present invention from “microporous materials” which also have high surface areas and may have some porosity in the meso-range but which have a substantial amount (i.e. at least 50%, more commonly at least 75%, most commonly at least 90%) of their surface area due to porosity in the range below 2 nm. The surface area of the mesoporous α-manganese dioxide of the present invention is generally greater than 110 m²/g, and more preferably at least 150 m²/g.

Surface area and pore size distribution, as defined herein, have been measured using nitrogen porosimetry analysis. In the case of surface area determination, this involves adsorption and desorption of a monolayer of nitrogen molecules on the surface of the material, and using the quantity of gas adsorbed in a calculation developed by Brunauer, Emmet and Teller to determine surface area. This method is thus known as the BET method. Pore size distribution is determined using an extended version of this method in which the nitrogen gas is allowed to fill the pores of a material (as opposed to creating a monolayer coverage). Measurement of the amount of gas required to fill the pores and the pressure at which pore filling occurs allows calculation of the pore size distribution of the material using a theory developed by Barrett, Joyner and Halenda. This is known as the BJH method. Adsorption isotherms rather than desorption isotherms were used to calculate the pore size distribution figures quoted and claimed herein. These methods are well known to those skilled in the art.

Where the MnO₂ is used to form an electrode for an electrochemical cell, in order to enhance the conductivity of the electrode, the mesoporous MnO₂ is preferably mixed with an electrically conductive powder, for example: carbon, preferably in the form of graphite, amorphous carbon, or acetylene black; nickel; or cobalt. If necessary, it may also be mixed with a binder, such as ethylene propylene diene monomer (EPDM), styrene butadiene rubber (SBR), carboxy methyl cellulose (CMC), polyvinyl diene fluoride (PVDF), polytetrafluoroethylene (PTFE), polyvinyl acetate or a mixture of any two or more thereof. The mesoporous MnO₂, electrically conductive powder and optionally the binder may be mixed with a solvent, such as hexane, water, cyclohexane, heptane, hexane, or N-methylpyrrolidone, and the resulting paste applied to a support, after which the solvent is removed by evaporation, leaving a mixture of the porous material and the electrically conductive powder and optionally the binder.

It may be desirable in some applications to construct an electrode for an electrochemical cell in which the active material is composed of a mixture of mesoporous manganese dioxide and manganese dioxide of the type conventionally used in battery or supercapacitor type electrode. For example, conventional MnO₂ materials that generally do not have internal mesoporosity within each particle may have high tap density and therefore high volumetric energy density but low power density by virtue of the large solid state diffusion distances. It may be advantageous for cost or performance reasons to mix such a material with the α-MnO₂ of the present invention that contains internal mesoporosity to impart high power density to the electrode and to the electrochemical cell constructed using such electrodes. In this way, the electrode and electrochemical cell have a combination of the properties of the two different electrode materials. A corollary of this is that the energy/power characteristics of the electrode and electrochemical cell may be tuned by varying the ratio of mesoporous α-MnO₂ to conventional material in the electrode such that higher ratios of α-MnO₂ to conventional MnO₂ favour higher power electrode and electrochemical cell designs.

The electrochemical cell also contains a negative electrode. This may be any material capable of use as a negative electrode in the appropriate electrochemical cell. Examples of such materials include lithium metal in the case where the cell is a primary lithium battery, carbon capable of facilitating lithium intercalation such as coke/graphite mixtures or titanium oxides and their lithiated forms where the cell is a rechargeable lithium ion battery, a high surface area activated carbon where the cell is an asymmetric supercapacitor or zinc where the cell is an alkaline primary battery. If necessary, these may be provided on a support, e.g. of aluminium, copper, tin or gold, preferably copper in the case of lithium ion batteries, unless it has sufficient structural strength in itself.

In cases where the MnO₂ is used as an electrode material in lithium or lithium ion batteries the electrolyte likewise may be any conventional such material, for example lithium hexafluorophosphate, lithium tetraborate, lithium perchlorate, or lithium hexafluoroarsenate, in a suitable solvent, e.g. ethylene carbonate, diethylene carbonate, dimethyl carbonate, propylene carbonate, or a mixture of any two or more thereof. Where the MnO₂ is used as an electrode material for use in asymmetric supercapacitors or in alkaline primary batteries suitable electrolytes include aqueous solutions of sulphuric acid and potassium hydroxide, respectively.

The cell may also contain a conventional separator, for example a microporous polypropylene or polyethylene membrane, porous glass fibre tissue or a combination of polypropylene and polyethylene.

Examples of electrochemical cells which may employ the α-phase mesoporous MnO₂ of the present invention include, but are not limited to, primary (non-rechargeable), secondary (rechargeable) lithium batteries, supercapacitors and alkaline primary batteries.

The invention is further illustrated by the following non-limiting Examples.

### EXAMPLE 1

### Mesoporous MnO₂ Templated from Brij 78

40 g of Brij 78 surfactant was added to 40.0 ml of 0.125 M sodium permanganate solution (aqueous) The resulting paste was stirred vigorously until homogeneous. The reaction vessel was sealed and then left for 15 hours in a 40° C. oven to react. The surfactant was removed from the resultant product via repeated washing with deionised water. The collected powder was dried at 60° C. for 2 days.

The resulting mesoporous MnO₂ had a surface area of 202 m²/g and a pore volume of 0.556 cm³/g as determined by nitrogen desorption. The pore size distribution also determined by nitrogen desorption is shown in FIG. 1 of the accompanying drawings. The small angle x-ray scattering peak, indicating the presence of some ordering on the mesoscale, is shown in FIG. 2. FIG. 3 shows the wide angle x-ray diffraction pattern, indicating the predominance of the α-phase on MnO₂. Analysis of chemical composition using energy dispersive x-ray measurement indicated a potassium ion (K⁺) concentration of approximately 7600 ppm.

### EXAMPLE 2

### Mesoporous MnO₂ Templated from Pluronic F127

88.0 ml of a 0.25 M sodium permanganate solution (aqueous) was added to 71.5 g of Pluronic F127 surfactant. The mixture was stirred vigorously until homogeneous. The reaction vessel was sealed then left for 3 hours in a 90° C. oven to react. The surfactant was removed from the resultant product via repeated washing in deionised water. The collected powder was dried at 60° C. for 2 days.

The mesoporous MnO₂ had a surface area of 239 m²/g and a pore volume of 0.516 cm³/g as determined by nitrogen desorption. The pore size distribution also determined by nitrogen desorption is shown in FIG. 4 of the accompanying drawings.

Analysis of chemical composition using energy dispersive x-ray measurement indicated a potassium ion (K⁺) concentration of approximately 8500 ppm.

### EXAMPLE 3

### Preparation of Mesoporous MnO₂ Electrode

1.0 g of the mesoporous MnO₂ powder produced in Example 5 was added to 0.062 g of carbon (Vulcan XC72R) and mixed by hand with a pestle and mortar for 5 minutes. Then 0.096 g of PTFE-solution (polytetrafluoroethylene suspension in water, 60 wt. % solids) was added to the mixture and mixed for a further 5 minutes with the pestle and mortar until a thick homogenous paste was formed.

The composite paste was fed through a rolling mill to produce a free standing film. Discs were then cut from the composite film using a 12.5 mm diameter die press and dried under vacuum at 120° C. for 24 hours. This resulted in a final dry composition of 90 wt. % MnO₂, 5 wt. % carbon and 5 wt. % PTFE.

### EXAMPLE 4

### Preparation of a Mesoporous MnO₂ Based Electrochemical Cell

An electrochemical cell was assembled in an Argon containing glove-box. The cell was constructed using an in-house designed sealed electrochemical cell holder. The mesoporous MnO₂ disc electrode produced in Example 3 was placed on an aluminium current collector disc and two glass fibre separators were placed on top. Then 0.5 mL of electrolyte (0.75 M lithium perchlorate in a three solvent equal mix of propylene carbonate, tetrahydrofuran and dimethoxyethane) was added to the separators. Excess electrolyte was removed with a pipette. A 12.5 mm diameter disc of 0.3 mm thick lithium metal foil was placed on the top of the wetted separator and the cell was sealed ready for testing.

### EXAMPLE 5

### Mesoporous MnO₂ Templated from Pluronic P123 with TEGMME

10.2 g of Pluronic P123 surfactant was heated until molten. To this was added 12.5 ml of 0.25 M aqueous sodium permanganate solution. The mixture was stirred vigorously until a homogeneous liquid crystal phase was formed, and then 0.490 ml of triethylene glycol monomethyl ether (TEGMME) was added and stirred through the mixture. Retention of the homogeneous liquid crystal phase was confirmed using polarizing light microscopy. The reaction vessel was then sealed and left for 3 hours in an oven at 90° C. to react. The surfactant was removed from the resultant product via repeated washing in deionised water. The collected powder was dried at 60° C. for 2 days.

The surface area of the material was measured as 185 m²/g using nitrogen porosimetry analysis with a pore volume of 0.293 cm³/g. FIG. 5 shows the pore size distribution of the material, confirming the presence of mesoporosity in the sample. X-ray diffraction measurements confirmed the presence of the α-phase of MnO₂.

### EXAMPLE 6

### Mesoporous MnO₂ Templated from Sodium Dodecyl Sulphate (SDS) with TEGMME

12.5 ml of 0.25 M aqueous sodium permanganate solution was mixed with 10.2 g of sodium dodecyl sulphate and 4.0 mL of dodecane. The reaction vessel was then sealed and left for 15 minutes in an oven at 80° C. to form a lyotropic liquid crystal phase. The reaction vessel was then removed from the oven and 0.490 mL of triethylene glycol monomethyl ether (TEGMME) was added and stirred through the mixture. Retention of the homogeneous liquid crystal phase was confirmed using polarizing light microscopy. The reaction vessel was then sealed and returned to the 80° C. oven for a further 3 hours to react: The surfactant was removed from the resultant manganese dioxide product via repeated washing in deionised water. The collected powder was dried at 60° C. for 2 days.

The surface area of the material was measured as 160 m²/g using nitrogen porosimetry analysis with a pore volume of 0.439 cm³/g. FIG. 6 shows the pore size distribution of the material, confirming the presence of mesoporosity in the sample. X-ray diffraction measurements confirmed the presence of the α-phase of MnO₂.

### EXAMPLE 7

### Preparation of Conventional MnO₇ Electrode

The procedure of Example 3 was repeated but replacing the mesoporous MnO₂ of Example 5 with a conventional, commercially available MnO₂ powder (Mitsui TAD-1 Grade).

### EXAMPLE 8

### Preparation of a Conventional MnO₂ Based Electrochemical Cell

The procedure of Example 4 was repeated but using a positive electrode fabricated using conventional MnO₂ as described in Example 7.

### EXAMPLE 9

### Testing of a MnO₂ Based Electrochemical Cell

The discharge currents required for 2C rate discharge of the electrochemical cells fabricated as described in Example 4 (mesoporous MnO₂) and Example 8 (conventional MnO₂) were calculated using a theoretical capacity of 308 mAh/g. The electrochemical cells were then discharged using these current values. The discharge curves for both cells are shown in FIG. 7 of the accompanying drawings.

1. Mesoporous α-manganese dioxide.

2. Mesoporous α-manganese dioxide according to claim 1, in which at least 60% of the manganese dioxide is in the α-phase.

3. Mesoporous α-manganese dioxide according to claim 1, in which at least 80% of the manganese dioxide is in the α-phase.

4. Mesoporous α-manganese dioxide according to claim 1, in which at least 90% of the manganese dioxide is in the α-phase.

5. Mesoporous α-manganese dioxide according to claim 1, in which at least 75% of the surface area is due to the presence of pores in the meso-range.

6. Mesoporous α-manganese dioxide according to claim 1, in which at least 90% of the surface area is due to the presence of pores in the meso-range.

7. Mesoporous α-manganese dioxide according to claim 1, in which the surface area is at least 110 m²/g.

8. Mesoporous α-manganese dioxide according to claim 7, in which the surface area is at least 150 m²/g.

9. Mesoporous α-manganese dioxide according to claim 1, containing cation impurities selected from K⁺ and/or Na⁺ and/or Rb⁺ cations, in which the sum of the content of said impurities is at least 0.2 atomic %.

10. Mesoporous α-manganese dioxide according to claim 9, in which the sum of the content of said impurities is at least 0.7 atomic %.

11. A process for the preparation of mesoporous α-manganese dioxide by the oxidation of a source of Mn(II), reduction of a source of Mn(VI) or Mn(VII), or dissociation of an Mn(II) salt, characterised in that the oxidation, reduction or dissociation reaction is carried out in the presence of a structure-directing agent in an amount sufficient to form an homogeneous lyotropic liquid crystalline phase in the reaction mixture, and under conditions such as to precipitate the manganese dioxide as a mesoporous solid in the α-phase.

12. Mesoporous α-manganese dioxide when prepared by a process according to claim 11.

13. An electrode comprising mesoporous α-manganese dioxide according to claim 1.

14. An electrode comprising a mixture of conventional MnO₂ and mesoporous α-manganese dioxide according to claim 1.

15. An electrochemical cell having an electrode according to claim 13.

16. An electrode comprising mesoporous α-manganese dioxide according to claim 12.

17. An electrode comprising a mixture of conventional MnO₂ and mesoporous α-manganese dioxide according to claim 12.

18. An electrochemical cell having an electrode according to claim 14.

19. An electrochemical cell having an electrode according to claim 16.

20. An electrochemical cell having an electrode according to claim 17.
